(19) United States
(12) Patent Application Publication
(10) Pub. No.: US 2010/0177894 A1
(43) Pub. Date: Jul. 15, 2010

(54) COMMUNICATION APPARATUS AND COMMUNICATION METHOD

(75) Inventors: Kensuke Yasuma, Tokyo (JP); Takafumi Nakajima, Mitaka-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/634,552

(22) Filed: Dec. 9, 2009

(30) Foreign Application Priority Data
Jan. 13, 2009 (JP) 2009-005132

(51) Int. Cl. H04L 9/00; G06F 15/16

(52) U.S. Cl. 380/255; 709/238

(57) ABSTRACT

When a communication apparatus transmits data to another communication apparatus, a network connected to the communication apparatus and a network connected to the other communication apparatus are searched for. It is determined, in accordance with a communication channel decided based on the search result, whether to execute encryption of the data to be transmitted. If it is determined to execute the encryption, the data is transmitted after encrypting at least part of it.

### BACKGROUND OF THE INVENTION

1. Field of the Invention

The present invention relates to a communication apparatus and a communication method.

2. Description of the Related Art

There is a technique of encrypting data in order to, for example, securely upload it. There also exists a technique of always encrypting a communication channel by, for example, SSL or IPSec regardless of data.

In an already secured communication channel, both data itself and the communication channel are encrypted. That is, the encryption is doubled. The same operation is conventionally performed irrespective of a network connected to a device.

There is proposed a technique of causing a wireless mobile terminal connectable to both an office environment and a mobile environment to discriminate between the office environment and the mobile environment, and when it is connected to the mobile environment, encrypting data and transmitting it to an information processing apparatus installed in an office (for example, Japanese Patent Laid-Open No. 10-150453).

In another technique proposed, data to be transmitted to an open network is encrypted, but data to be transmitted to a network with which limits user access is not encrypted (for example, Japanese Patent Laid-Open No. 2000-138703).

In the prior arts, however, whether to execute encryption is not decided based on the current connected network and connection destination. Hence, even in a secure network, wasteful encryption processing is performed for some connection destinations.

### SUMMARY OF THE INVENTION

The present invention provides an apparatus and method capable of determining whether to execute encryption of data to be transmitted by a communication apparatus connected to a network.

According to one aspect of the present invention, there is provided a communication apparatus comprising: a determination unit that determines whether or not to execute encryption of data in accordance with a communication channel from the communication apparatus to another communication apparatus when the data is transmitted to the another communication apparatus; and an encryption unit that encrypts at least part of the data in a case where it is determined by the determination unit that the encryption is to be executed.

According to another aspect of the present invention, there is provided a communication method executed in a communication apparatus, comprising: determining whether or not to execute encryption of data in accordance with a communication channel from the communication apparatus to another communication apparatus when the data is transmitted to the another communication apparatus; and encrypting at least part of the data in a case where it is determined in the determining step that the encryption is to be executed.

Further features of the present invention will become apparent from the following description of exemplary embodiments (with reference to the attached drawings).

### BRIEF DESCRIPTION OF THE DRAWINGS

FIG. 1 is a block diagram showing an example of a network configuration according to the first embodiment;

FIG. 2 is a block diagram showing an example of the arrangement of a network connection apparatus 102 according to the first embodiment;

FIG. 3 is a block diagram showing the functional modules of the network connection apparatus 102 according to the first embodiment;

FIG. 4 is a flowchart illustrating setting processing of the network connection apparatus 102 according to the first embodiment;

FIG. 5 is a view showing examples of communication parameters according to the first embodiment;

FIG. 6 is a sequence chart showing the communication sequence of the setting processing between the network connection apparatus 102 and a DMS 103;

FIG. 7 is a flowchart illustrating upload processing of the network connection apparatus 102;

FIG. 8 is a sequence chart showing a sequence of connecting the network connection apparatus 102 to an access point 104 and uploading an image to the DMS 103;

FIG. 9 is a block diagram showing a case in which the network connection apparatus 102 has moved close to a hot spot 106;

FIG. 10 is a sequence chart showing a sequence of connecting the network connection apparatus 102 to the hot spot 106 and uploading an image to a proxy server 107;

FIG. 11 is a block diagram showing an example of the functional modules of a network connection apparatus 102 according to the second embodiment;

FIG. 12 is a flowchart illustrating upload processing of the network connection apparatus 102 according to the second embodiment;

FIG. 13 is a sequence chart showing a sequence of connecting the network connection apparatus 102 to a hot spot 106 and uploading an image using IPSec;

FIG. 14 is a view showing examples of communication parameters according to the third embodiment;

FIGS. 15A and 15B are flowcharts illustrating upload processing of a network connection apparatus 102 according to the third embodiment;

FIG. 16 is a block diagram showing an example of a network configuration according to the fourth embodiment;

FIG. 17 is a block diagram showing an example of the arrangement of a network connection apparatus 1600 according to the fourth embodiment;

FIG. 18 is a block diagram showing the module arrangement of the network connection apparatus 1600 according to the fourth embodiment;

FIG. 19 is a flowchart illustrating communication parameter setting processing of the network connection apparatus 1600 according to the fourth embodiment;

FIG. 20 is a flowchart illustrating download processing of the network connection apparatus 1600 according to the fourth embodiment;

FIG. 21 is a sequence chart showing a sequence of communication parameter setting and content transfer between a Viewer 1601, an access point 104, and the network connection apparatus 1600;

FIG. 22 is a view showing the communication parameters of the access point 104 held in the network connection apparatus 1600 according to the fourth embodiment;

FIG. 23 is a view showing a registered terminal list according to the fourth embodiment; and

FIG. 24 is a sequence chart showing a sequence of communication parameter setting and download between the Viewer 1601, a hot spot 106, a router 105, and the network connection apparatus 1600.

### DESCRIPTION OF THE EMBODIMENTS

The best mode for carrying out the present invention will now be described in detail with reference to the accompanying drawings.

### First Embodiment

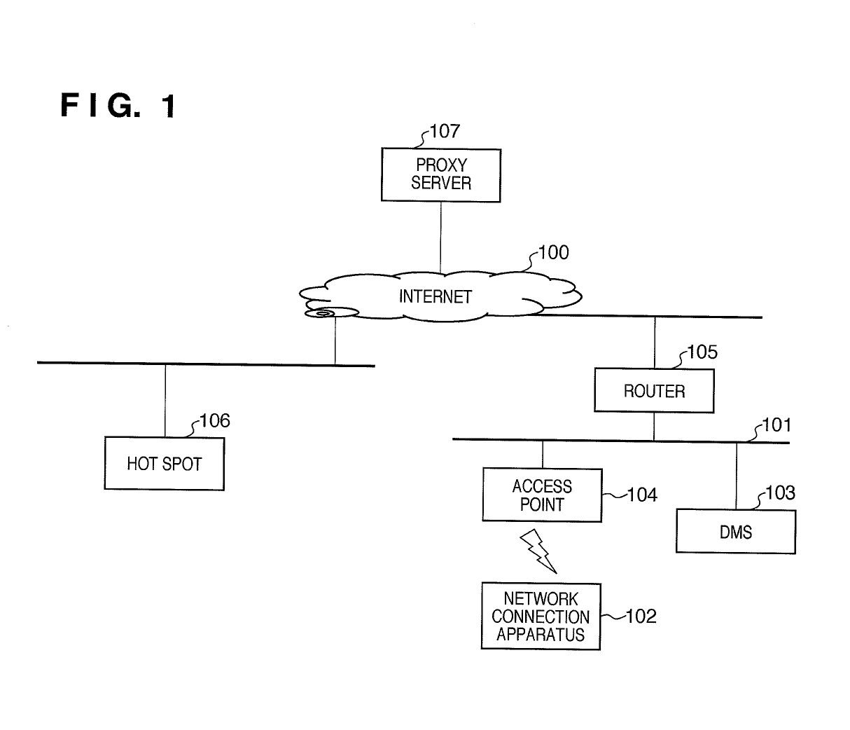

FIG. 1 is a block diagram showing an example of a network configuration according to the first embodiment. A DMS (Digital Media Server) 103, access point 104, and router 105 are connected to a LAN 101 shown in FIG. 1. The LAN 101 may be, for example, Ethernet®, Bluetooth®, Zigbee, or UWB, or a combination thereof.

The router 105, a hot spot 106, and a proxy server 107 are connected to Internet 100. The Internet 100 may be a WAN (Wide Area Network) or LAN (Local Area Network), or a combination thereof.

A network connection apparatus 102 serving as a communication apparatus can be connected to the LAN 101 via the access point 104. The network connection apparatus 102 can search for the DMS 103 or upload images to the DMS 103 using an M-DMU (Mobile Digital Media Uploader) function. The network connection apparatus 102 can also search for the proxy server 107 or upload data to the proxy server 107 using TCP.

Note that upload to the DMS can be done not only by M-DMU but also using any other upload method using +UP+, TCP, or UDP. Upload to the proxy server 107 can be done not only by TCP but also using any other upload method using UDP, UDP/IPSec, TCP/IPSec, SSL, TLS, or DTLS.

The DMS 103 supports DLNA (Digital Living Network Alliance) and has a function of receiving data uploaded using DMS+Upload and a function of decoding data. Note that the DMS 103 of the first embodiment may be an M-DMS (Mobile Digital Media Server).

The uploaded data reception function need not always be DMS+Upload. It may be M-DMS+Upload. Alternatively, any other upload method using TCP or UDP can be used.

The access point 104 is connected to the wired LAN and wireless LAN of the LAN 101. The router 105 is connected to both the Internet 100 and the LAN 101 to control packet transfer or the like. The hot spot 106 is a public hot spot connected to the Internet 100. The hot spot 106 is not limited to the public hot spot. It may be a non-public wireless LAN in a hotel or the like or a wireless LAN using a cellular phone.

The proxy server 107 is connected to the Internet 100, and upon receiving a data transfer request from the network connection apparatus 102, transfers data to the DMS 103.

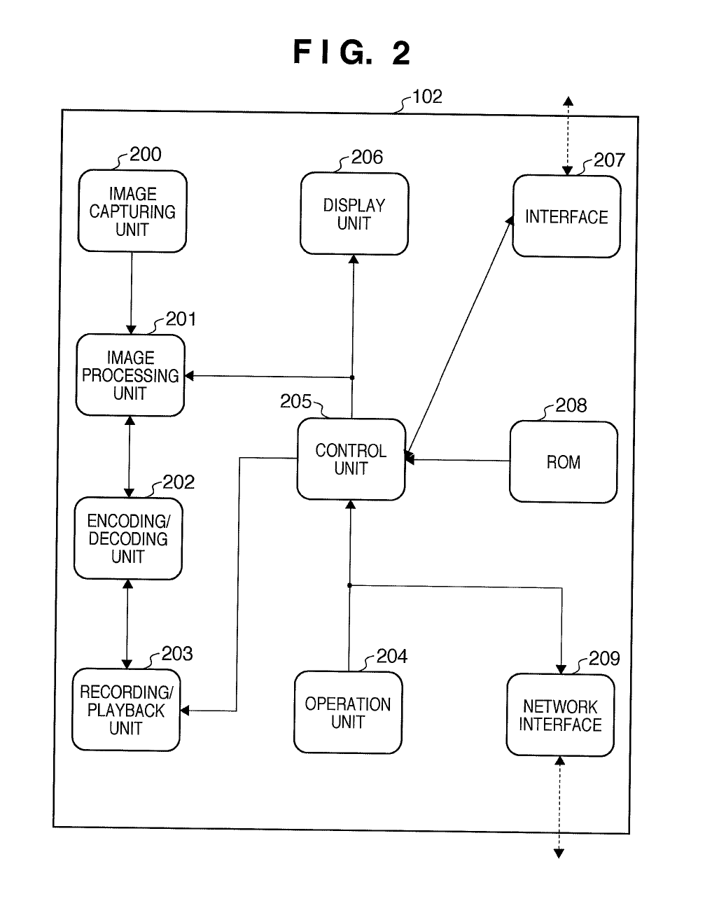

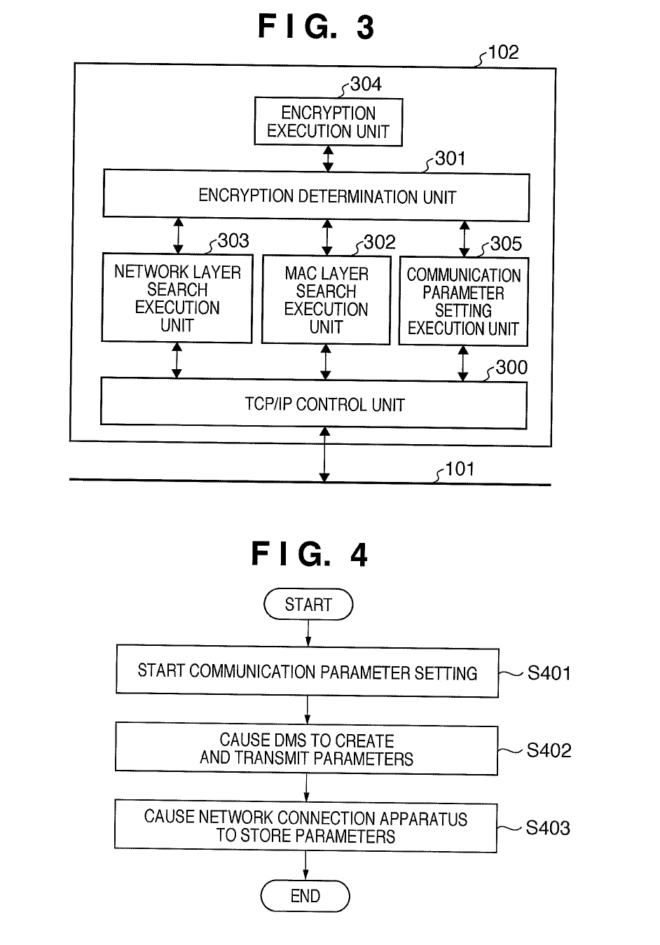

The arrangement and functional modules of the network connection apparatus 102 shown in FIG. 1 will be described here with reference to FIGS. 2 and 3.

FIG. 2 is a block diagram showing an example of the arrangement of the network connection apparatus 102 according to the first embodiment. In the first embodiment, a digital camera will be exemplified as the network connection apparatus 102. However, the present invention is not limited to this. FIG. 3 is a block diagram showing an example of the functional module arrangement of the network connection apparatus 102.

In the network connection apparatus 102, an image capturing unit 200 captures an optical image of an object. An image processing unit 201 converts the captured image output from the image capturing unit 200 into image data of a predetermined format and adds watermark data to the image data. An encoding/decoding unit 202 performs predetermined high-efficiency encoding (variable-length coding after DCT transform and quantization) for the image data output from the image processing unit 201. The encoding/decoding unit 202 also decompresses compressed image data played back by a recording/playback unit 203 and supplies the image data to the image processing unit 201.

The recording/playback unit 203 records the compression-coded image data in a recording medium (not shown) or plays back recorded image data. An operation unit 204 gives the instruction for a processing operation on the network connection apparatus 102. A control unit 205 includes a microcomputer and a memory capable of storing predetermined program codes. The control unit 205 controls the operations of the processing units of the network connection apparatus 102 and also performs, for example, processing concerning a UPnP device.

A display unit 206 displays the image captured by the image capturing unit 200 using EVF (Electronic ViewFinder) or a liquid crystal panel. An interface 207 communicates, for example, image data captured by the image capturing unit 200.

A ROM 208 stores information about the functions of the network connection apparatus 102, control programs, and the like. Note that the network connection apparatus 102 compression-codes image data by, for example, JPEG (Joint Photographic Experts Group). A network interface (NETIF) 209 controls data transfer between communication apparatuses via the network and diagnoses the connection state.

The functional modules of the network connection apparatus 102 shown in FIG. 3 are stored in the ROM 208 and executed by the control unit 205. Some or all of the functional modules may be formed by hardware.

A TCP/IP control unit 300 is connected to the LAN 101 to process TCP/IP. An encryption determination unit 301 requests a MAC layer search execution unit 302 to search for a connectable wireless LAN based on information acquired by communication parameter setting of a communication parameter setting execution unit 305. Upon receiving the search result from the MAC layer search execution unit 302, the encryption determination unit 301 decides, from the result of the encryption determination unit 301, a network to be connected so that the apparatus is connected to the network.

The encryption determination unit 301 also requests a network layer search execution unit 303 based on the search result from the MAC layer search execution unit 302. When the apparatus is connected to a network of a registered SSID, the encryption determination unit 301 requests the network layer search execution unit 303 to perform a search by SSDP and search for the DMS 103. SSID stands for Service Set IDentifier, and SSDP for Simple Service Discovery Protocol. Upon finding the DMS 103, the encryption determination unit 301 directly transmits data to the DMS 103.

When the apparatus is connected to a network whose SSID is not registered, the encryption determination unit 301 requests the network layer search execution unit 303 to perform a search by DNS (Domain Name System) and search for the proxy server 107. Upon finding the proxy server 107, the encryption determination unit 301 requests an encryption execution unit 304 to encrypt data to be transmitted. The encryption determination unit 301 transmits the encrypted data to the proxy server 107 and requests it to transfer the data to the DMS 103.

The MAC layer search execution unit 302 executes a search in a MAC layer using a network identifier such as an SSID. In the first embodiment, a wireless LAN is used. Instead, Bluetooth®, Zigbee, UWB, or the like may be used.

The network layer search execution unit 303 executes a search in a network layer by, for example, DNS, DDNS (Dynamic DNS), mDNS, SSDP, WS-Discovery, or SIP. In the first embodiment, SSDP and DNS are used. Instead, DDNS, mDNS, WS-Discovery, SIP, or the like may be used. WS-Discovery stands for Web Services Dynamic Discovery, and SIP for Session Initiation Protocol.

The encryption execution unit 304 executes encryption in accordance with an instruction received from the encryption determination unit 301. In the first embodiment, the encryption execution unit 304 receives a request from the encryption determination unit 301 and encrypts image data using AES (Advanced Encryption Standard). However, the encryption scheme is not limited to AES. DES (Data Encryption Standard), Triple-DES, or the like is also applicable.

The communication parameter setting execution unit 305 executes communication parameter setting in accordance with an instruction received from the encryption determination unit 301. The communication parameter setting execution unit 305 receives, from the DMS 103, parameters to be used to connect to the access point 104 or parameters to be used to access the DMS 103 and sets them as communication parameters.

FIG. 4 is a flowchart illustrating setting processing of the network connection apparatus 102 according to the first embodiment. First, when the user starts up the application and requests the encryption determination unit 301 to start communication parameter setting, processing starts.

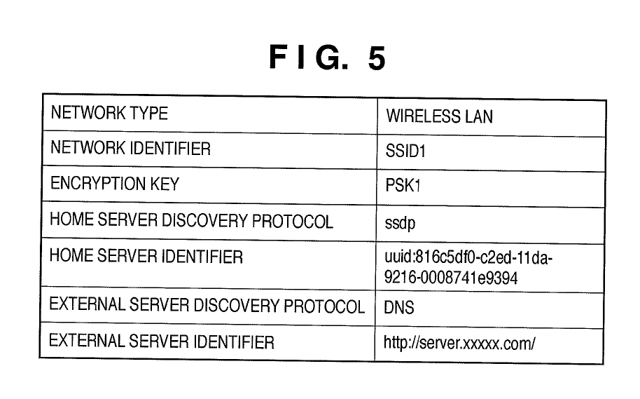

In step S401, the encryption determination unit 301 starts communication parameter setting for the DMS 103 to acquire communication parameters (FIG. 5) to be used to access the access point 104 and the DMS 103. The encryption determination unit 301 instructs the communication parameter setting execution unit 305 to execute communication parameter setting.

In step S402, the communication parameter setting execution unit 305 transmits a communication parameter setting request to the DMS 103. Upon receiving the communication parameter setting request from the communication parameter setting execution unit 305, the DMS 103 creates the communication parameters and transmits them to the communication parameter setting execution unit 305.

In step S403, the communication parameter setting execution unit 305 receives the communication parameters from the DMS 103 and stores them. The processing thus ends.

FIG. 5 is a view showing examples of communication parameters according to the first embodiment. “Network type” indicates a wireless network type such as wireless LAN or Bluetooth®. In this example, a wireless LAN is used. “Network identifier” is an identifier for identifying a network. In this example, since a wireless LAN is used, the network is identified by an SSID, and SSID1 is set.

“Encryption key” is a key to be used to encrypt a wireless network or an image. In this example, PSK1 is set. “Home server discovery protocol” is a protocol to be used to discover a home server in the network identified by the network identifier. In this example, ssdp is set. “Home server identifier” is an identifier to be used by the home server discovery protocol to identify a home server. In this example, a uuid used in ssdp is set.

“External server discovery protocol” is a protocol to be used to discover an external server which is to be used to upload an image from outside the network corresponding to the network identifier. In this example, DNS is set. “External server identifier” is an external server identifier to be used by the external server discovery protocol. In this example, a URL is set.

In the example shown in FIG. 5, one communication parameter is set for each item. However, not one but a plurality of communication parameters may be set for each item. For example, the communication parameters may include a plurality of external server discovery protocols and a plurality of external server identifiers corresponding to them.

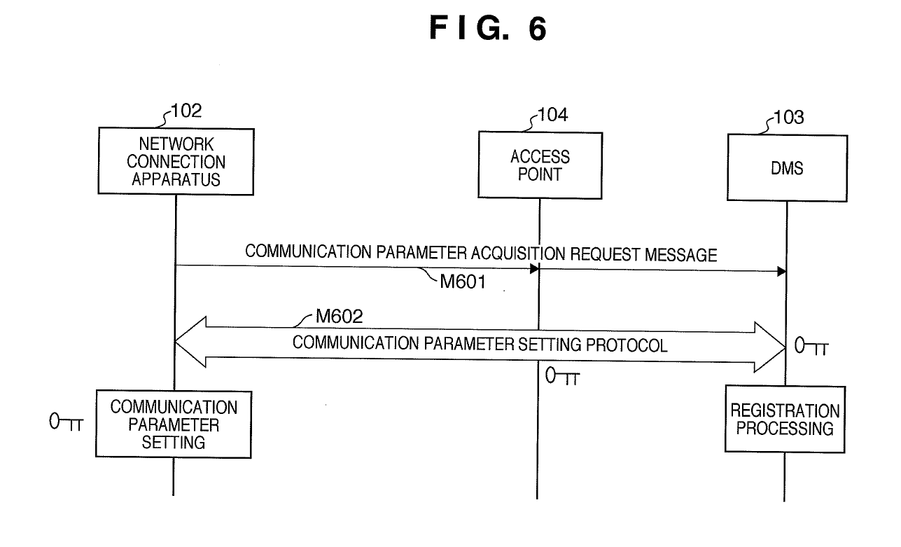

FIG. 6 is a sequence chart showing the communication sequence of the setting processing between the network connection apparatus 102 and the DMS 103. First, the network connection apparatus 102 transmits a communication parameter acquisition request message M601 to the DMS 103. In response to the communication parameter acquisition request message M601, the DMS 103 executes the communication parameter setting protocol. The DMS 103 transmits the encryption key of the access point 104 to the network connection apparatus 102. The network connection apparatus 102 sets the communication parameters received from the DMS 103.

In the first embodiment, the encryption key of the access point 104 is used. However, the processing can also be implemented using another encryption key such as an encryption key to be used for a wired network.

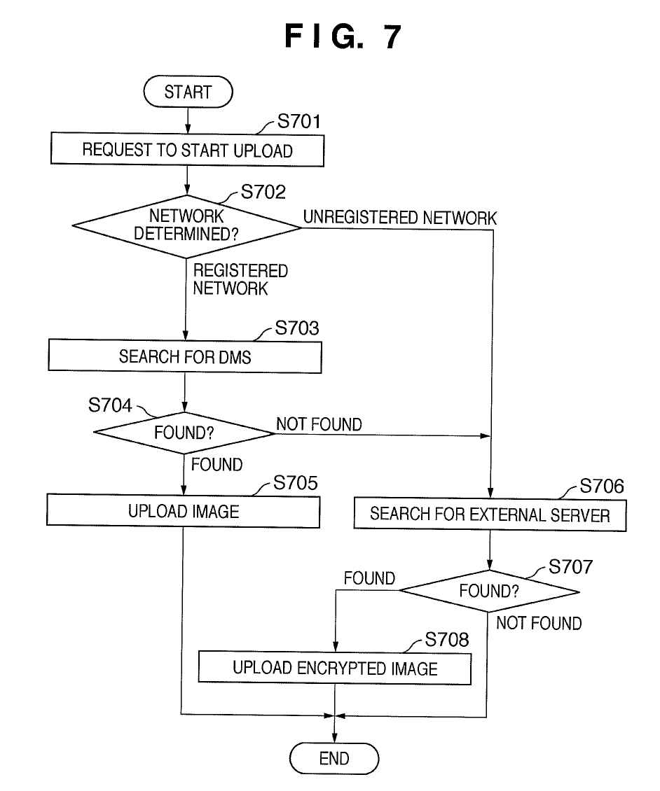

FIG. 7 is a flowchart illustrating upload processing of the network connection apparatus 102. In step S701, the user requests, via the application, the encryption determination unit 301 to start upload. The encryption determination unit 301 receives the upload start request, and advances the process to step S702.

In step S702, the encryption determination unit 301 requests the MAC layer search execution unit 302 to execute connection to a network. Based on the communication parameter “network type”, the MAC layer search execution unit 302 determines the network to be searched for as a wireless LAN. The MAC layer search execution unit 302 acquires SSID1 from the communication parameter “network identifier” and determines whether a network corresponding to SSID1 exists.

If the MAC layer search execution unit 302 has found a network corresponding to SSID1, it is determined that a registered network has been found, and the process advances to step S703. If the MAC layer search execution unit 302 has not found a network corresponding to SSID1, it is determined that an unregistered network has been found, and the process advances to step S706.

In step S703, the encryption determination unit 301 is notified of the connection to the registered network by the MAC layer search execution unit 302, and decides to upload an image to the home server. The encryption determination unit 301 requests the network layer search execution unit 303 to search for a DMS using the home server discovery protocol ssdp and the home server identifier. The home server identifier is uuid:816c5df0-c2ed-11da-9216-0008741e9394shown in FIG. 5.

The network layer search execution unit 303 executes a DMS search in response to the DMS search request, and advances the process to step S704. In step S704, if the network layer search execution unit 303 has found a corresponding DMS, it notifies the encryption determination unit 301 of the found DMS information, and advances the process to step S705. If the network layer search execution unit 303 has not found a corresponding DMS, it notifies the encryption determination unit 301 that no DMS has been found, and advances the process to step S706.

In step S705, the encryption determination unit 301 uploads the image based on the DMS information, and ends the processing. In step S706, the encryption determination unit 301 decides to upload the image to an external server. The encryption determination unit 301 requests the network layer search execution unit 303 to search for an external server using the external server protocol DNS and the external server identifier. The external server identifier is http://server.canon.com/. The network layer search execution unit 303 executes a DNS search in response to the external server search request, and advances the process to step S707.

In step S707, if the network layer search execution unit 303 has found a corresponding external server, it sends the found external server information to the encryption determination unit 301, and advances the process to step S708. If the network layer search execution unit 303 has not found a corresponding external server, it notifies the encryption determination unit 301 that no external server has been found, and ends the processing.

In step S708, the encryption determination unit 301 requests the encryption execution unit 304 to encrypt the image data. The encryption execution unit 304 encrypts the image data using the encryption key PSK1. The encryption execution unit 304 then sends the encrypted image data to the encryption determination unit 301. The encryption determination unit 301 uploads the encrypted image data to the external server, and ends the processing.

An outline of the operation of the network connection apparatus 102 will be described next. When an image data upload destination is set and designated, the network connection apparatus 102 receives communication parameters from the DMS 103 in accordance with FIGS. 4 and 6. The network connection apparatus 102 can be connected to the access point 104 using the encryption key included in the communication parameters.

If the network connection apparatus 102 can receive a radio wave from the access point 104 at the start of image upload, it uploads the image to the DMS 103.

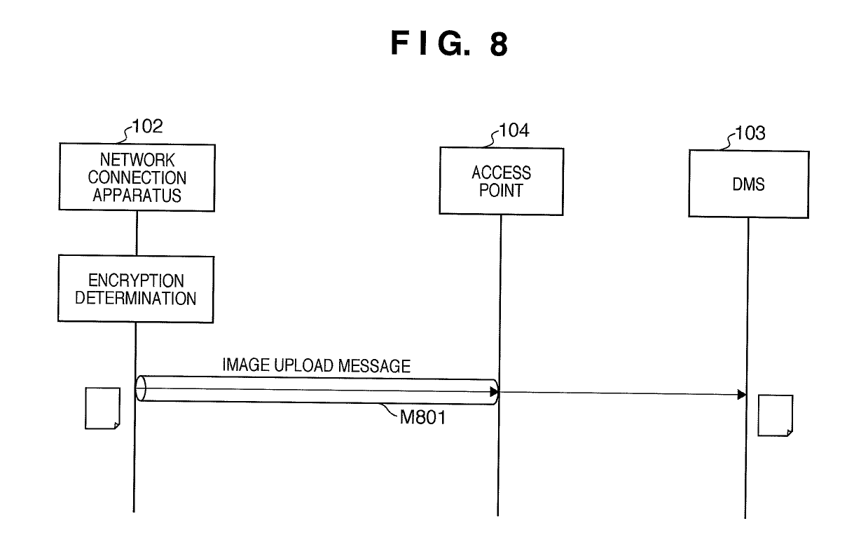

FIG. 8 is a sequence chart showing a sequence of connecting the network connection apparatus 102 to the access point 104 and uploading an image to the DMS 103. The network connection apparatus 102 executes encryption determination, sends an image upload message M801 to the DMS 103 via the access point 104, and uploads an image in plaintext to the DMS 103. Note that the network connection apparatus 102 is wirelessly connected to the access point 104. The wireless section between the network connection apparatus 102 and the access point 104 is encrypted by an encryption key.

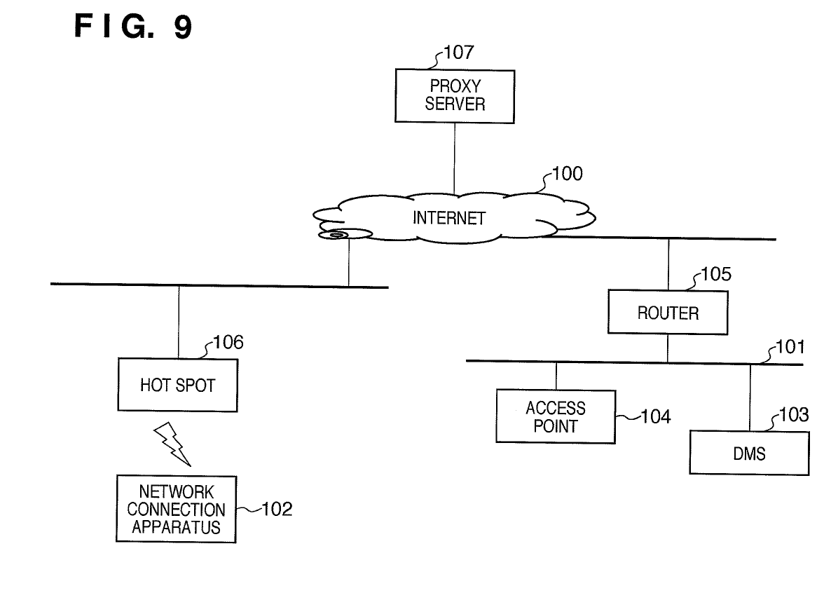

FIG. 9 is a block diagram showing a case in which the network connection apparatus 102 has moved close to the hot spot 106. Referring to FIG. 9, upon receiving an image upload instruction, the network connection apparatus 102 finds the hot spot 106 that is an unregistered network in accordance with the flowchart in FIG. 6. The network connection apparatus 102 is connected to the hot spot 106 and uploads an encrypted image to the proxy server 107.

The proxy server 107 receives the encrypted image data and transfers it to the DMS 103. The DMS 103 acquires the encrypted image data. The DMS 103 decrypts the encrypted image data as needed using the common key PSK1.

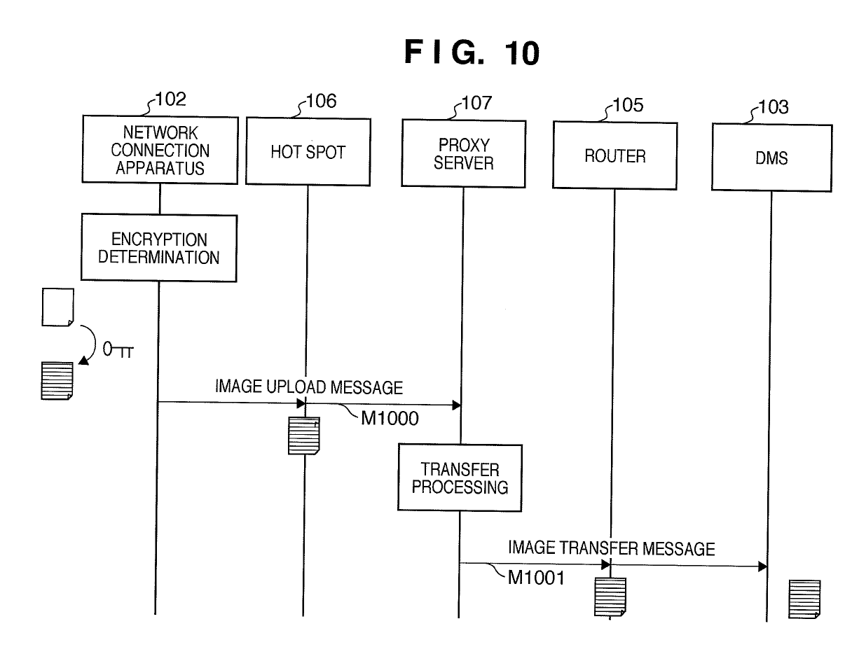

FIG. 10 is a sequence chart showing a sequence of connecting the network connection apparatus 102 to the hot spot 106 and uploading an image to the proxy server 107. Upon determining as a result of a search to upload an image to the proxy server 107, the network connection apparatus 102 executes image encryption processing. The network connection apparatus 102 transmits an image upload message M1000 to the proxy server 107. The image upload message M1000 contains the encrypted upload target image.

The proxy server 107 transfers the encrypted upload target image contained in the image upload message M1000 to the DMS 103. The DMS 103 can thus acquire the encrypted image data.

On the proxy server 107, since only the encrypted image data exists, it is impossible to peep at the image itself. That is, in the present invention, even if the proxy server 107 is a malicious server, the image itself is encrypted and can therefore be prevented from being peeping at.

As described above, the network connection apparatus 102 can securely perform upload via the proxy server 107.

### Second Embodiment

The second embodiment of the present invention will be described next in detail with reference to the accompanying drawings. A network connection apparatus 102 of the second embodiment holds a wireless network interface and a wired network interface. Note that the network configuration of the second embodiment is the same as that of the first embodiment shown in FIG. 1, and a description thereof will not be repeated.

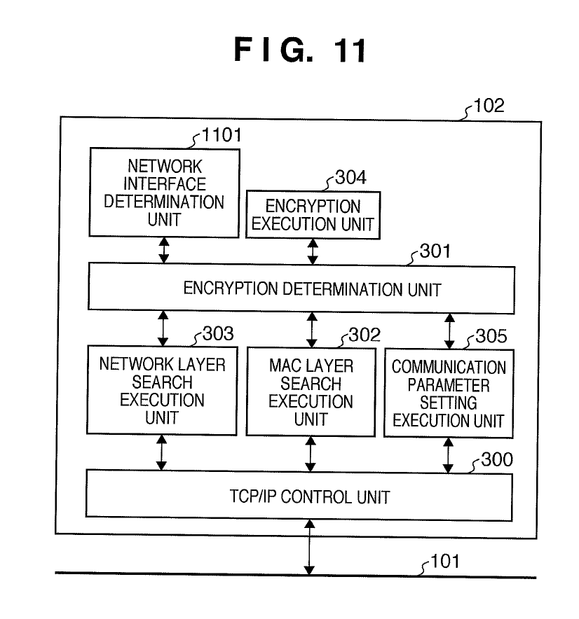

FIG. 11 is a block diagram showing an example of the functional module arrangement of the network connection apparatus 102 according to the second embodiment. A network interface determination unit 1101 shown in FIG. 11 discriminates between a wireless network and a wired network of a LAN. Discrimination between a wireless network and a wired network of a LAN is done. However, the present invention is not limited to this.

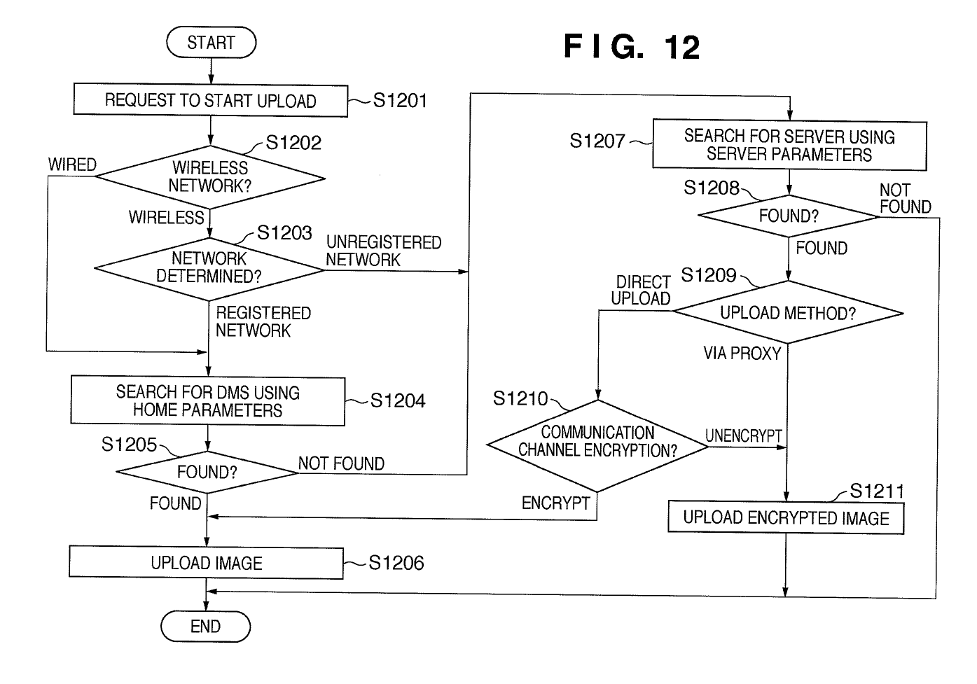

FIG. 12 is a flowchart illustrating upload processing of the network connection apparatus 102 according to the second embodiment. In step S1201, the user requests, via the application, an encryption determination unit 301 to start upload. The encryption determination unit 301 receives the upload start request, and requests the network interface determination unit 1101 in step S1202 to determine a network interface to be used now. Upon determining to use a wired LAN, the network interface determination unit 1101 notifies the encryption determination unit 301 of the determination result, and advances the process to step S1204. Upon determining to use a wireless LAN, the network interface determination unit 1101 notifies the encryption determination unit 301 of the determination result, and advances the process to step S1203.

In step S1203, the encryption determination unit 301 requests a MAC layer search execution unit 302 to execute connection to a network. Based on the communication parameter “network type”, the MAC layer search execution unit 302 determines the network to be searched for as a wireless LAN. The MAC layer search execution unit 302 acquires SSID1 from the communication parameter “network identifier” and determines whether a network corresponding to SSID1 exists. If the MAC layer search execution unit 302 has found a network corresponding to SSID1, it is determined that a registered network has been found, and the process advances to step S1204. If the MAC layer search execution unit 302 has not found a network corresponding to SSID1, it is determined that an unregistered network has been found, and the process advances to step S1207.

In step S1204, the encryption determination unit 301 is notified of the connection to the registered network by the MAC layer search execution unit 302, and decides to upload an image to the home server. The encryption determination unit 301 requests a network layer search execution unit 303 to search for a DMS using the home server discovery protocol ssdp and the home server identifier. The home server identifier is uuid:816c5df0-c2ed-11da-9216-0008741e9394. The network layer search execution unit 303 executes a DMS search in response to the DMS search request, and advances the process to step S1205.

In step S1205, if the network layer search execution unit 303 has found a corresponding DMS, it notifies the encryption determination unit 301 of the found DMS information, and advances the process to step S1206. If the network layer search execution unit 303 has not found a corresponding DMS, it notifies the encryption determination unit 301 that no DMS has been found, and advances the process to step S1207.

In step S1206, the encryption determination unit 301 uploads the image based on the DMS information, and ends the processing.

In step S1207, the encryption determination unit 301 decides to upload the image to an external server. The encryption determination unit 301 requests the network layer search execution unit 303 to search for an external server using the external server protocol DNS and the external server identifier http://server.canon.com/. The network layer search execution unit 303 executes a DNS search in response to the external server search request, and advances the process to step S1208.

In step S1208, if the network layer search execution unit 303 has found a corresponding external server, it sends the found external server information to the encryption determination unit 301, and advances the process to step S1209. If the network layer search execution unit 303 has not found a corresponding external server, it notifies the encryption determination unit 301 that no external server has been found, and ends the processing.

In step S1209, the encryption determination unit 301 determines the upload method. If a DMS 103 has the function of a web server, and the router has done NAT setting or the like, the server can be made open to the public. If the DMS 103 is open to the public, the external network connection apparatus 102 can directly upload an image to the DMS 103. Upon determining to directly upload an image to the DMS 103, the encryption determination unit 301 advances the process to step S1210.

Upon determining to upload an image via a proxy server 107, the encryption determination unit 301 advances the process to step S1211. Note that the proxy is merely an example, and any other method of indirectly uploading data is usable. For example, a method of temporarily storing data in the server and then transferring it to the DMS 103 may be applied.

In step S1210, the encryption determination unit 301 determines whether the communication channel to be used for upload to the DMS 103 is encrypted. If IPSec is already used between the network connection apparatus 102 and the DMS 103, the encryption determination unit 301 determines that the communication channel has been encrypted. Note that the IPSec is merely an example, and any other communication channel encryption scheme such as SSL is also applicable.

If the encryption determination unit 301 has determined that the communication channel to be used for upload is encrypted, the process advances to step S1206. If the encryption determination unit 301 has determined that the communication channel to be used for upload is not encrypted, the process advances to step S1211.

In step S1211, the encryption determination unit 301 requests an encryption execution unit 304 to encrypt the image data. The encryption execution unit 304 encrypts the image data using the encryption key PSK1. The encryption execution unit 304 then sends the encrypted image data to the encryption determination unit 301. The encryption determination unit 301 uploads the encrypted image data to the external server, and ends the processing.

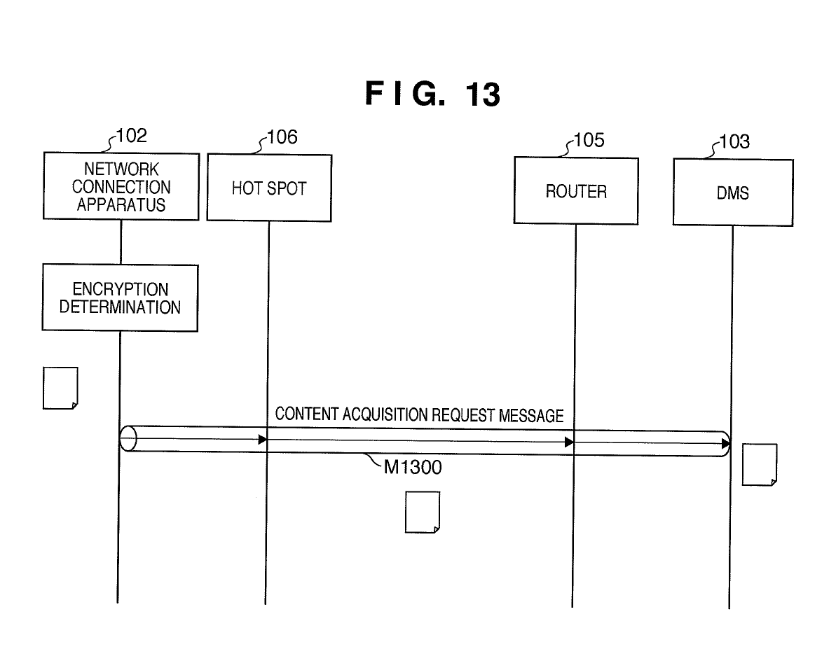

FIG. 13 is a sequence chart showing a sequence of connecting the network connection apparatus 102 to a hot spot 106 and uploading an image using IPSec. In this case, the network connection apparatus 102 ensures a secure communication channel by IPSec for the DMS 103. That is, the network connection apparatus 102 determines that a secure communication channel is ensured, and does not encrypt the image to be uploaded.

Using the secure communication channel, the network connection apparatus 102 uploads an unencrypted image to the DMS 103 via a content acquisition request message M1300. The DMS 103 can acquire the image data.

According to the second embodiment, wasteful processing such as double encryption is suppressed to reduce the overhead of encryption processing. The arrangement supports both a wired network and a wireless network. Hence, the user can unconsciously use a wired network or a wireless network, and the operation becomes easier.

### Third Embodiment

The third embodiment of the present invention will be described next in detail with reference to the accompanying drawings. Note that the arrangement of a network connection apparatus 102 according to the third embodiment is the same as that of the second embodiment, and a description thereof will not be repeated.

Communication parameters of the third embodiment include home server identifiers corresponding to a plurality of home server discovery protocols and external server identifiers corresponding to a plurality of external server discovery protocols.

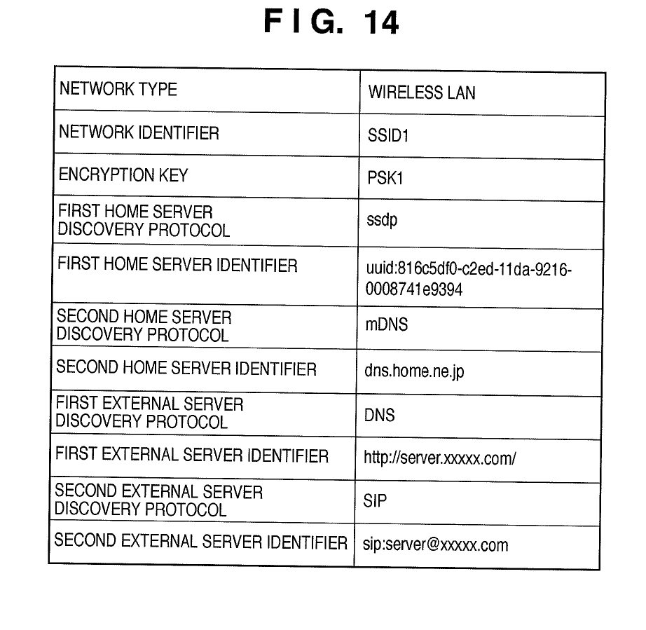

FIG. 14 is a view showing examples of communication parameters according to the third embodiment. In the third embodiment as well, the network connection apparatus 102 acquires the communication parameters.

“Network type” indicates a wireless network type such as wireless LAN or Bluetooth®. In this example, a wireless LAN is used. For the descriptive convenience, the parameter includes only one network type. However, the parameter may include a plurality of network types, and an optimum one may be selected. “Network identifier” is an identifier for identifying a network. In this example, since a wireless LAN is used, the network is identified by an SSID. SSID1 is set. For the descriptive convenience, the parameter includes only one network identifier. However, the parameter may include a plurality of network identifiers, and an optimal one may be selected.

“Encryption key” is a key to be used to encrypt a wireless network or an image. In this example, PSK1 is set. “First home server discovery protocol” is a protocol to be used to discover a home server in the network indicated by the network identifier. In this example, ssdp is set. “First home server identifier” is an identifier to be used by the home server discovery protocol to identify a home server. In this example, a uuid used in ssdp is set.

“Second home server discovery protocol” is a protocol to be used to discover a home server in the network indicated by the network identifier. In this example, mDNS is set. “Second home server identifier” is an identifier to be used by the home server discovery protocol to identify a home server. In this example, a URL used in mDNS is set.

“First external server discovery protocol” is a protocol to be used to discover an external server which is to be used to upload an image from outside the network corresponding to the network identifier. In this example, DNS is set. “First external server identifier” is an external server identifier to be used by the external server discovery protocol. In this example, a URL is set.

“Second external server discovery protocol” is a protocol to be used to discover an external server which is to be used to upload an image from outside the network corresponding to the network identifier. In this example, SIP is set. “Second external server identifier” is an external server identifier to be used by the external server discovery protocol. In this example, a URI of SIP is set.

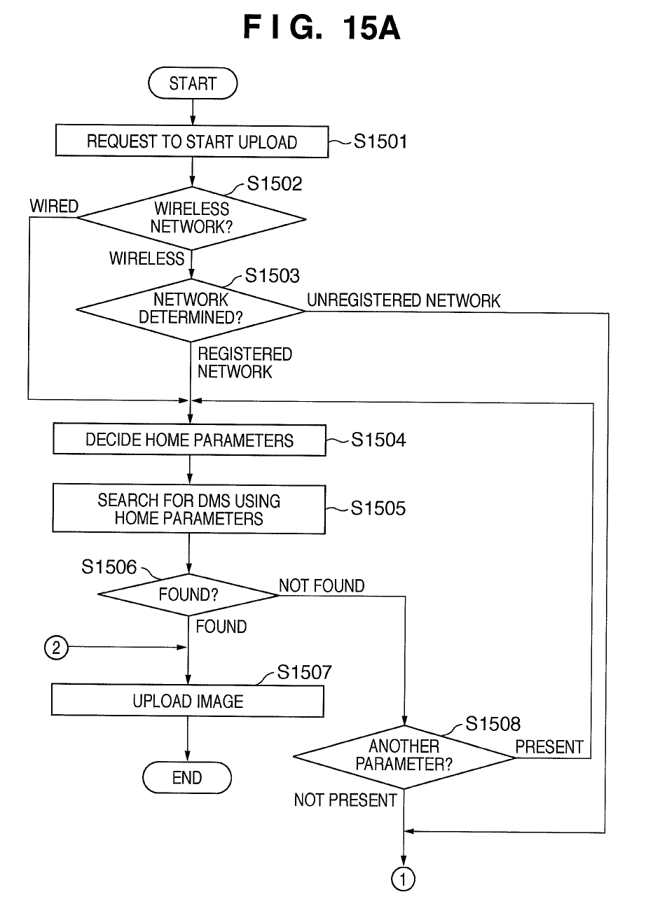

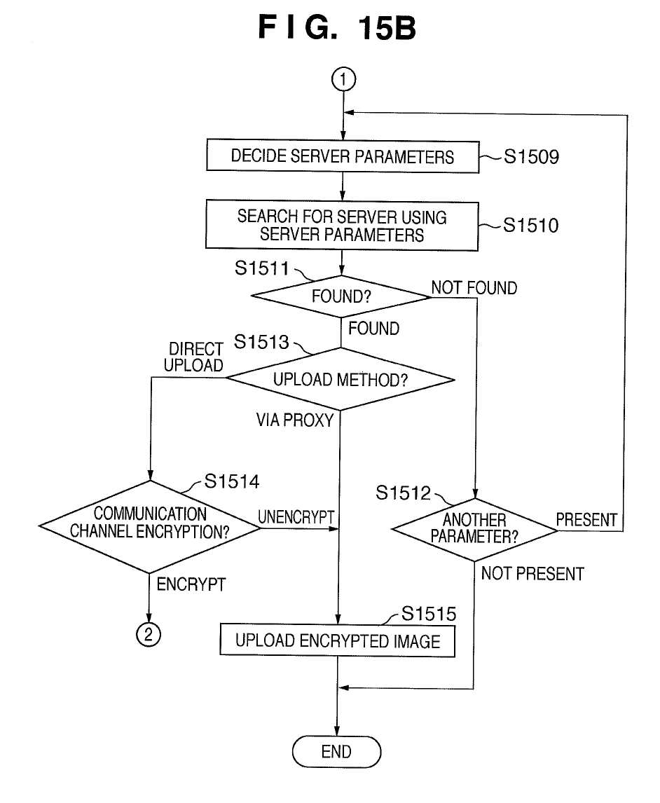

FIGS. 15A and 15B are flowcharts illustrating upload processing of the network connection apparatus 102 according to the third embodiment. In step S1501, the user requests, via the application, an encryption determination unit 301 to start upload. Upon receiving the upload start request, the encryption determination unit 301 advances the process to step S1502.

In step S1502, the encryption determination unit 301 requests a network interface determination unit 1101 to determine a network interface to be used now. Upon determining to use a wired LAN, the network interface determination unit 1101 notifies the encryption determination unit 301 of the determination result, and advances the process to step S1504. Upon determining to use a wireless LAN, the network interface determination unit 1101 notifies the encryption determination unit 301 of the determination result, and advances the process to step S1503.

For the descriptive convenience, the parameters include only one network type and only one network identifier. However, the number need not always be one, and a plurality of network types and a plurality of network identifiers may be held. In this case, in step S1502, an optimum network is selected based on the plurality of network types and network identifiers, and one network is searched for from the plurality of networks.

In step S1503, the encryption determination unit 301 requests a MAC layer search execution unit 302 to execute connection to a network. Based on the communication parameter “network type”, the MAC layer search execution unit 302 determines the network to be searched for as a wireless LAN. The MAC layer search execution unit 302 acquires SSID1 from the communication parameter “network identifier” and determines whether a network corresponding to SSID1 exists. If the MAC layer search execution unit 302 has found a network corresponding to SSID1, it is determined that a registered network has been found, and the process advances to step S1504. If the MAC layer search execution unit 302 has not found a network corresponding to SSID1, it is determined that an unregistered network has been found, and the process advances to step S1509.

In step S1504, the encryption determination unit 301 is notified of the connection to the registered network by the MAC layer search execution unit 302. The encryption determination unit 301 decides to upload an image to a DMS 103. Next, the encryption determination unit 301 decides, out of the communication parameters, parameters to be used to find the DMS 103. In this example, the encryption determination unit 301 uses the first home server discovery protocol and the first home server identifier. If the first discovery protocol has already been executed, the encryption determination unit 301 uses the second home server discovery protocol and the second home server identifier.

For the descriptive convenience, the discovery protocols are executed in order. However, the present invention is not limited to this, and searches may be done simultaneously. Alternatively, the second home server discovery protocol and the second home server identifier may be used first. There are no restrictions to the parameter selection method. For example, the search method may be changed depending on which network is connected. Otherwise, parameters which were found by the preceding search may be stored, and a search may be executed using them.

In step S1505, the encryption determination unit 301 is notified of the connection to the registered network by the MAC layer search execution unit 302. The encryption determination unit 301 decides to upload an image to the home server. The encryption determination unit 301 requests a network layer search execution unit 303 to search for a DMS using the home server discovery protocol decided in step S1504 and the home server identifier decided in step S1504. The network layer search execution unit 303 executes a DMS search in response to the DMS search request, and advances the process to step S1506.

In step S1506, if the network layer search execution unit 303 has found a corresponding DMS, it notifies the encryption determination unit 301 of the found DMS information, and advances the process to step S1507. If the network layer search execution unit 303 has not found a corresponding DMS, it notifies the encryption determination unit 301 that no DMS has been found, and advances the process to step S1508.

In step S1507, the encryption determination unit 301 uploads the image based on the found DMS information, and ends the processing.

In step S1508, the encryption determination unit 301 determines whether there is a home server parameter which has not been used to execute a search. If the encryption determination unit 301 has determined that there is a home server parameter which has not been used to execute a search, the process advances to step S1504. If the encryption determination unit 301 has determined that there is no home server parameter which has not been used to execute a search, the process advances to step S1509.

In step S1509, the encryption determination unit 301 determines that the apparatus is connected to an unregistered network. The encryption determination unit 301 decides to upload an image to a proxy server 107. Next, the encryption determination unit 301 decides, out of the communication parameters, parameters to be used to find the proxy server 107. In this example, the encryption determination unit 301 uses the first external server discovery protocol and the first external server identifier. If the first external server discovery protocol has already been executed, the encryption determination unit 301 uses the second external server discovery protocol and the second external server identifier.

For the descriptive convenience, the discovery protocols are executed in order. However, the present invention is not limited to this, and searches may be done simultaneously. Alternatively, the second external server discovery protocol and the second external server identifier may be used first. In this example, there are no restrictions to the parameter selection method. For example, the search method may be changed depending on which network is connected. Otherwise, parameters which were found by the preceding search may be stored, and a search may be executed using them.

In step S1510, the encryption determination unit 301 requests the network layer search execution unit 303 to search for an external server using the external server discovery protocol and external server identifier decided in step S1509. The network layer search execution unit 303 searches for the proxy server 107 in response to the external server search request, and advances the process to step S1511.

In step S1511, if the network layer search execution unit 303 has found a corresponding external server, it sends the found external server information to the encryption determination unit 301, and advances the process to step S1513. If the network layer search execution unit 303 has not found a corresponding external server, it notifies the encryption determination unit 301 that no external server has been found, and advances the process to step S1512.

In step S1512, the encryption determination unit 301 determines whether there is an external server parameter which has not been used to execute a search. If the encryption determination unit 301 has determined that there is an external server parameter which has not been used to execute a search, the process advances to step S1504. If the encryption determination unit 301 has determined that there is no external server parameter which has not been used to execute a search, the process advances to step S1509.

In step S1513, the encryption determination unit 301 determines the upload method. If the DMS 103 has the function of a web server, and the router has done NAT setting or the like, the server can be made open to the public. If the DMS 103 is open to the public, the external network connection apparatus 102 can directly upload an image to the DMS 103.

Upon determining to directly upload an image to the DMS 103, the encryption determination unit 301 advances the process to step S1514. Upon determining to upload an image via the proxy server 107, the encryption determination unit 301 advances the process to step S1515. The proxy is merely an example, and any other method of indirectly uploading data is usable. For example, a method of temporarily storing data in the server and then transferring it to the DMS 103 may be applied.

In step S1514, the encryption determination unit 301 determines whether the communication channel to be used for upload to the DMS 103 is encrypted. If IPSec is already used between the network connection apparatus 102 and the DMS 103, the encryption determination unit 301 determines that the communication channel has been encrypted. In this embodiment, the IPSec is merely an example, and any other communication channel encryption scheme such as SSL is also applicable. If the encryption determination unit 301 has determined that the communication channel to be used for upload is encrypted, the process advances to step S1507. If the encryption determination unit 301 has determined that the communication channel to be used for upload is not encrypted, the process advances to step S1515.

In step S1515, the encryption determination unit 301 requests an encryption execution unit 304 to encrypt the image data. The encryption execution unit 304 encrypts the image data using the encryption key PSK1. The encryption execution unit 304 then sends the encrypted image data to the encryption determination unit 301. The encryption determination unit 301 uploads the encrypted image data to the external server, and ends the processing.

According to the third embodiment, wasteful processing of executing a plurality of searches can be suppressed. It is consequently possible to shorten the time up to encryption determination and shorten the time up to data transmission.

### Fourth Embodiment

The fourth embodiment of the present invention will be described next in detail with reference to the accompanying drawings.

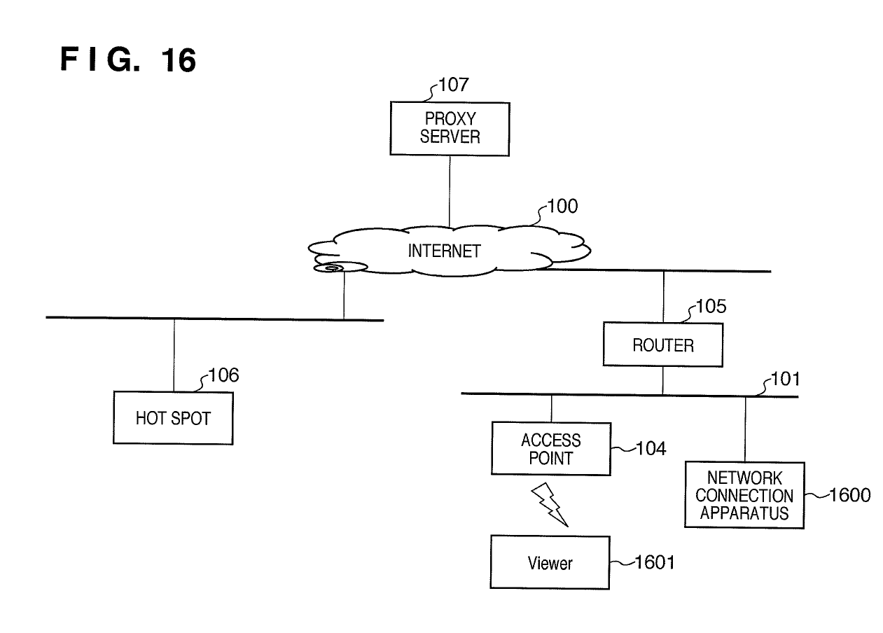

FIG. 16 is a block diagram showing an example of a network configuration according to the fourth embodiment. The network configuration is the same as in the first embodiment except a network connection apparatus 1600 and a Viewer 1601.

The network connection apparatus 1600 is connected to an access point 104 via a LAN 101. The network connection apparatus 1600 is also connected to a router 105 via the LAN 101 so as to be capable of communication via Internet 100.

The network connection apparatus 1600 also has a wireless LAN communication parameter providing function, and provides communication parameters using a wireless LAN communication parameter setting protocol. In this example, the wireless LAN communication parameters of the access point 104 can be provided using the wireless LAN communication parameter setting protocol.

The network connection apparatus 1600 also has a DMS function. Hence, the network connection apparatus 1600 can provide a content such as an image to a DMP (Digital Media Player) or the like.

The Viewer 1601 has a wireless LAN communication function and can be connected to the LAN 101 via the access point 104. The Viewer 1601 has a DMP function. Hence, the Viewer 1601 can search the DMS (network connection apparatus) 1600 and play back a content in the DMS.

The Viewer 1601 also has a wireless LAN communication parameter setting protocol and can therefore execute a communication parameter setting protocol for the network connection apparatus 1600.

Note that the components other than the network connection apparatus 1600 and the Viewer 1601 are the same as in the first embodiment, and a description thereof will not be repeated.

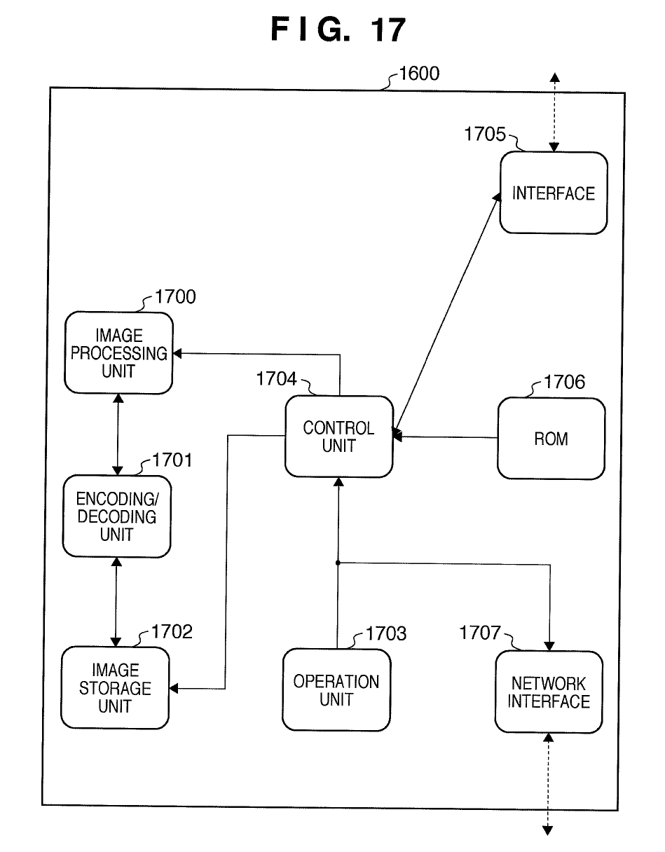

FIG. 17 is a block diagram showing an example of the arrangement of the network connection apparatus 1600 according to the fourth embodiment. An image processing unit 1700 converts an image transferred to the network connection apparatus 1600 by, for example, communication into image data of a predetermined format and adds watermark data to the image data. An encoding/decoding unit 1701 performs predetermined high-efficiency encoding (for example, variable-length coding after DCT transform and quantization) for the image data output from the image processing unit 1700. The encoding/decoding unit 1701 also transfers compressed image data to an image storage unit 1702 or encodes/decodes image data acquired from the image storage unit 1702. The image storage unit 1702 stores images and supplies them in response to a request.

An operation unit 1703 gives the instruction for a processing operation on the network connection apparatus 1600. A control unit 1704 includes a microcomputer and a memory capable of storing predetermined program codes. The control unit 1704 controls the operations of the processing units of the network connection apparatus 1600 and also performs, for example, processing concerning a UPnP device.

An interface 1705 communicates, for example, image data which the image processing unit 1700 has acquired from the image storage unit 1702 and processed. A ROM 1706 stores information about the functions of the network connection apparatus 1600. A network interface 1707 controls data transfer between information processing apparatuses via the network and diagnoses the connection state. Note that the network connection apparatus 1600 compression-codes image data by, for example, JPEG.

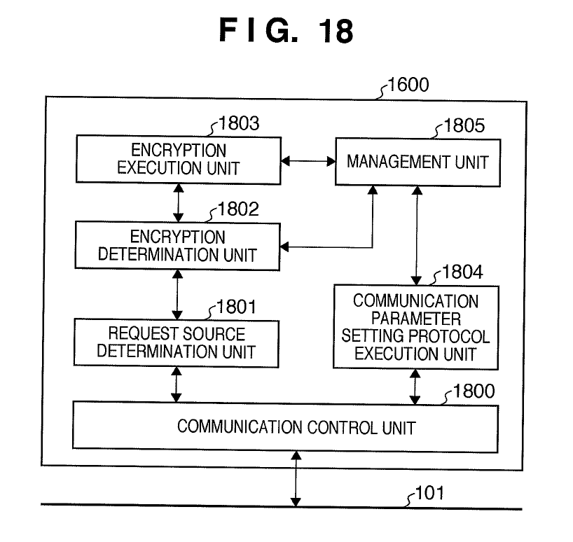

FIG. 18 is a block diagram showing the module arrangement of the network connection apparatus 1600 according to the fourth embodiment. The modules of the network connection apparatus 1600 are stored in the ROM 1706 and executed by the control unit 1704. Some or all of the modules of the network connection apparatus 1600 may be formed by hardware.

A communication control unit 1800 is connected to the LAN 101 to perform communication processing with another communication apparatus. A request source determination unit 1801 receives an image data request message from the other communication apparatus, and determines whether the request source which has sent the request message exists in the same subnetwork. The request source determination unit 1801 can also determine whether a secure communication with the request source has been established or whether to transmit image data to the request source.

An encryption determination unit 1802 determines, based on information from the request source determination unit 1801 and a management unit 1805, whether to encrypt the requested image data. When the encryption determination unit 1802 has determined to perform encryption, an encryption execution unit 1803 encrypts the image data using information from the management unit 1805.

A communication parameter setting protocol execution unit 1804 receives a communication parameter setting protocol start message and performs communication parameter setting protocol processing. The communication parameter setting protocol execution unit 1804 provides the communication parameters of the access point to a terminal apparatus for which the communication parameter setting protocol processing has normally ended.

The management unit 1805 registers and manages the information of the terminal for which the communication parameter setting protocol execution unit 1804 has done the communication parameter setting. As the terminal management information, pieces of information of a terminal identifier and a common key included in the provided communication parameters are registered and managed as a registered terminal list. The management information is used by the encryption determination unit 1802 and the encryption execution unit 1803.

In the fourth embodiment, the Viewer 1601 is connected to the access point 104 via a wireless LAN to download an image content from the network connection apparatus 1600 so that the image is played back in the Viewer 1601.

At this time, the Viewer 1601 acquires the communication parameters of the access point 104 and the wireless LAN by a communication parameter setting protocol between the access point 104 and the network connection apparatus 1600.

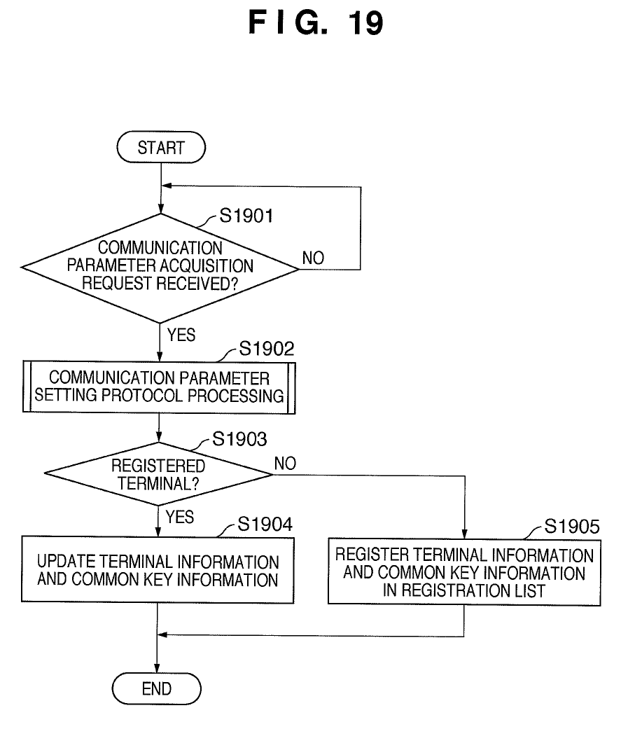

Operation examples according to the fourth embodiment will be explained below with reference to FIGS. 19, 20, 21, 22, and 23.

FIG. 19 is a flowchart illustrating communication parameter setting processing of the network connection apparatus 1600 according to the fourth embodiment. When the network connection apparatus 1600 receives a communication parameter acquisition request from a wireless LAN terminal (S1901), communication parameter setting protocol processing starts (S1902). When the communication parameter setting protocol processing has normally ended, the network connection apparatus 1600 transfers the communication parameters of the access point registered in it to the communication parameter acquisition request source.

After the communication parameter setting protocol processing, it is determined whether the terminal is registered in the registered terminal list (S1903). Upon determining that the terminal is unregistered in the registered terminal list, the terminal information (terminal identifier) and a common key included in the transmitted communication parameters are registered in the registered terminal list as a new registered terminal (S1905). On the other hand, if the terminal is already registered in the registered terminal list, the common key is updated in accordance with the terminal information (S1904). After the registration in the terminal list has finished, the communication parameter setting processing ends.

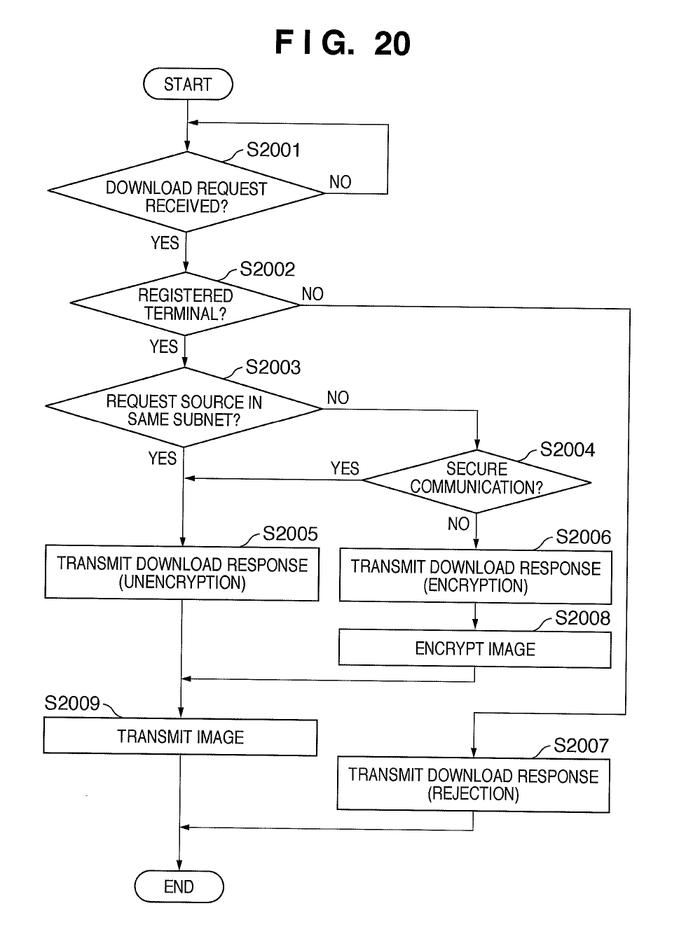

FIG. 20 is a flowchart illustrating download processing of the network connection apparatus 1600 according to the fourth embodiment. In step S2001, the network connection apparatus 1600 receives a download request, and advances the process to step S2002. In step S2002, the apparatus determines whether the request source terminal which has sent the received download request is already registered in the registered terminal list. Whether the terminal is already registered is determined using a MAC address as a registered terminal identifier. In this case, the MAC address of the request source terminal is contained in the download request message. The MAC address is compared with each MAC address in the registered terminal list, thereby determining whether the terminal is already registered.

Upon determining that the terminal is registered, the process advances to step S2003. Upon determining that the terminal is not registered, the process advances to step S2007. In step S2007, the apparatus transmits a download response containing a download rejection message, and ends the processing.

On the other hand, in step S2003, the apparatus determines whether the download request transmission source terminal exists in the same subnet. Upon determining in this network determination processing that the terminal exists in the same subnet, the process advances to step S2005. Upon determining that the terminal does not exist in the same subnet, the process advances to step S2004.

In step S2004, the apparatus determines whether the communication with the request source is secure. Whether the communication is secure is determined by determining whether the communication uses, for example, SSL. Upon determining that the communication is secure, the process advances to step S2005. If it is determined that the communication is not secure, the process advances to step S2006.

In step S2005, the apparatus transmits a download response containing a message representing that the requested image is to be transmitted without being encrypted, and advances the process to step S2009. On the other hand, in step S2006, the apparatus transmits a download response containing a message representing that the requested image is to be encrypted and transmitted, and advances the process to step S2008. In step S2008, the apparatus encrypts the requested image using a common key corresponding to the terminal identifier registered in the registered terminal list, and advances the process to step S2009. Finally in step S2009, the apparatus transmits the requested image, and ends the processing.

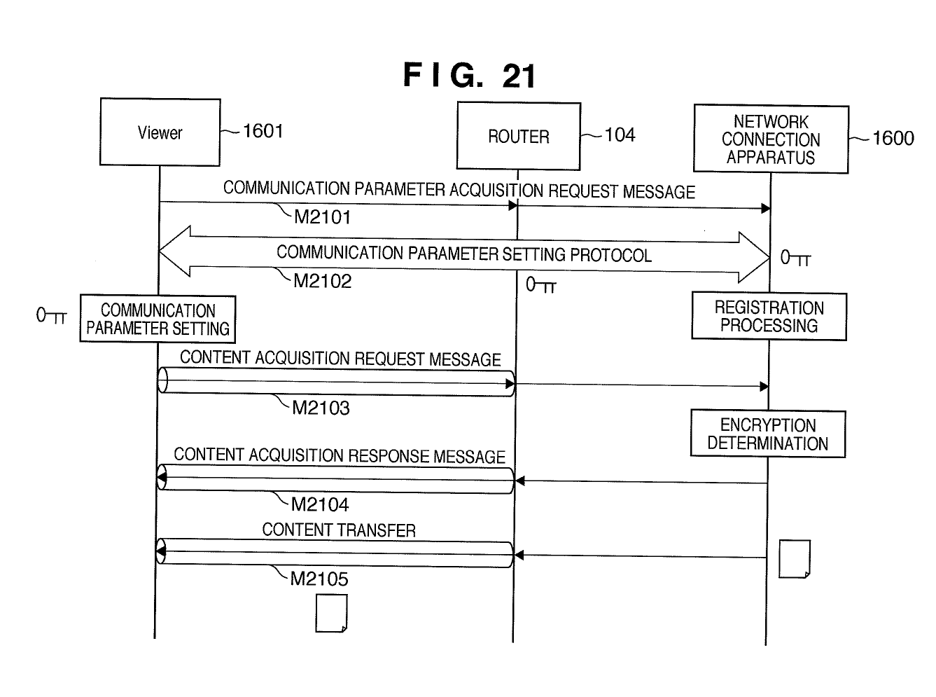

FIG. 21 is a sequence chart showing a sequence of communication parameter setting and content transfer between the Viewer 1601, access point 104, and network connection apparatus 1600. First, to acquire the communication parameters of the access point 104, the Viewer 1601 transmits a communication parameter acquisition request message M2101. The access point 104 transfers the communication parameter acquisition request message M2101 to the network connection apparatus 1600.

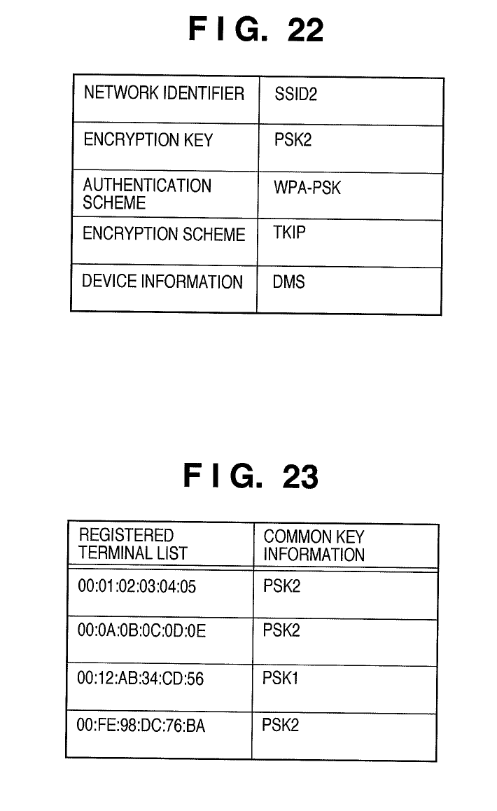

Upon receiving the communication parameter acquisition request message M2101, the network connection apparatus 1600 starts a communication parameter setting protocol M2102 with the Viewer 1601 via the access point 104. By the communication parameter setting protocol processing, the Viewer 1601 acquires the communication parameters of the access point 104. The communication parameters of the access point 104 according to the fourth embodiment are shown in FIG. 22.

FIG. 22 is a view showing the communication parameters of the access point 104 held in the network connection apparatus 1600 according to the fourth embodiment.

“Network identifier” is an identifier for discriminating a network. In this example, since a wireless LAN is used, the network is identified by an SSID. SSID2 is set.

“Encryption key” is a common key to be used to encrypt a wireless LAN network. A content is also encrypted using the common key.

“Authentication scheme” indicates an authentication scheme to be used to encrypt a wireless LAN network. In this example, WPA-PSK is set.

“Encryption scheme” is an encryption scheme to be used to encrypt a wireless LAN network. In this example, TKIP is set.

As an extension, device information or the like can also be included. In this example, DMS is set as the device information of the network connection apparatus 1600.

After acquiring the communication parameters of the access point 104, the Viewer 1601 sets the communication parameters in itself to enable data communication via the access point 104. At this time, a secure communication channel is established between the Viewer 1601 and the access point 104 by the encryption scheme, encryption key, and the like set in the communication parameters.

After that, the network connection apparatus 1600 registers, in the registered terminal list (FIG. 23), the terminal for which the communication parameter setting protocol processing has normally ended. In the fourth embodiment, the MAC address of the terminal is registered as a registered terminal.

In the example shown in FIG. 23, the MAC address 00:FE:98:DC:76:BA of the Viewer 1601 is registered in the registered terminal list. The common key (PSK2) included in the provided communication parameters is also registered together.

After the communication parameter setting processing has ended, the Viewer 1601 transmits a content acquisition request message M2103 as a request to acquire a content held in the network connection apparatus 1600. In this case, the Viewer 1601 transmits its MAC address (00:FE:98:DC:76:BA) contained in the payload of the content acquisition request message M2103.

Upon receiving the content acquisition request message M2103, the network connection apparatus 1600 performs encryption determination processing to determine whether to encrypt the content.

First, registered terminal determination processing (S2002 in FIG. 20) is executed to determine whether the terminal is registered. To do this, the apparatus determines whether the MAC address contained in the payload of the content acquisition request message M2103 is registered in the registered terminal list. In this example, since the MAC address of the Viewer 1601 is registered in the registered terminal list, the terminal is determined as a terminal registered in the registered terminal list.

After the registered terminal determination processing, the network connection apparatus 1600 performs network determination processing. In this case, the transmission source MAC address included in the Ether header of the content acquisition request message M2103 is compared with the MAC address of the terminal registered in the registered terminal list, thereby determining whether the terminal is registered in the registered terminal list.

Since the transmission source MAC address included in the Ether header of the content acquisition request message is the MAC address (00:FE:98:DC:76:BA) of the Viewer 1601, it is determined as the MAC address of the registered terminal. Hence, the Viewer 1601 is determined as a terminal in the same subnet, and the apparatus determines not to encrypt the content.

As a response to the content acquisition request message M2103, the network connection apparatus 1600 transmits a content acquisition response message M2104 to the Viewer 1601. In the fourth embodiment, the content acquisition response message M2104 includes a message representing that an unencrypted content is to be transmitted.

After transmitting the content acquisition response message M2104, the network connection apparatus 1600 transmits the requested content to the Viewer 1601 without encrypting it (M2105).

Another operation example according to the fourth embodiment will be explained next. In this example, the Viewer 1601 already registered in the registered terminal list of the network connection apparatus 1600 moves to the area of a hot spot 106 and downloads a content from the hot spot 106 via the Internet.

Assume that the Viewer 1601 is connected to the hot spot 106 via a wireless LAN and holds preset information for connection to the network connection apparatus 1600. The information for connection includes, for example, the information of a port capable of communicating with the network connection apparatus 1600 via a router 105, and the dDNS (dynamic DNS) information and URL information of the network connection apparatus 1600. Using these pieces of information, the Viewer 1601 is connected to the network connection apparatus 1600 to establish a communication channel.

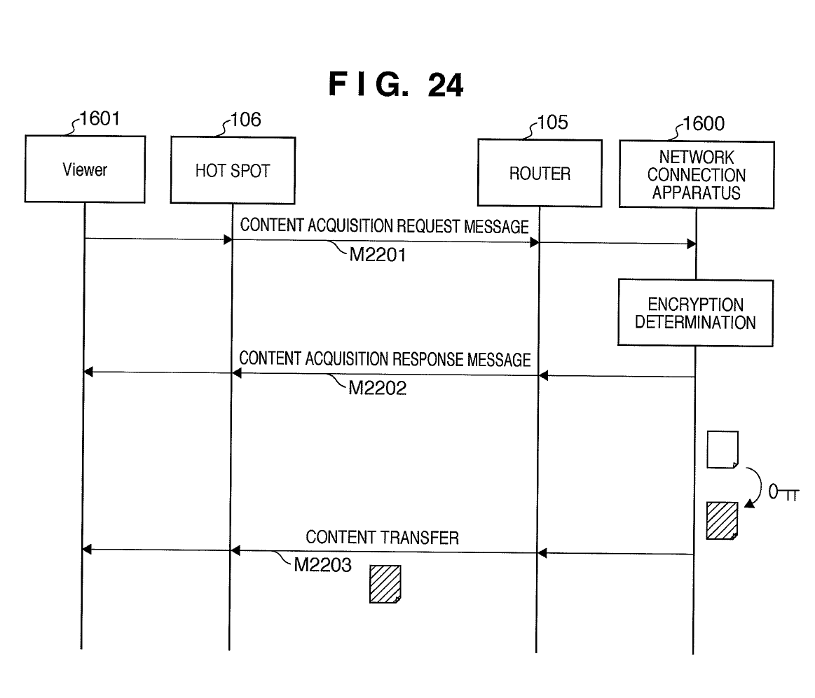

FIG. 24 is a sequence chart showing a sequence of communication parameter setting and download between the Viewer 1601, hot spot 106, router 105, and network connection apparatus 1600. First, the Viewer 1601 transmits a content acquisition request message M2201 to the network connection apparatus 1600 via the hot spot 106, Internet 100, and router 105. In this case, the Viewer 1601 transmits its MAC address (00:FE:98:DC:76:BA) contained in the payload of the content acquisition request message M2201.

Upon receiving the content acquisition request message M2201, the network connection apparatus 1600 performs encryption determination processing. First, registered terminal determination processing is executed to determine whether the terminal is registered. More specifically, the apparatus determines whether the MAC address contained in the payload of the content acquisition request message M2201 is registered in the registered terminal list. In this example, since the MAC address of the Viewer 1601 is registered in the registered terminal list, the terminal is determined as a terminal registered in the registered terminal list.

After the registered terminal determination processing, the network connection apparatus 1600 performs network determination processing. In this case, the transmission source MAC address included in the Ether header of the content acquisition request message M2201 is compared with the MAC address of the terminal registered in the registered terminal list, thereby determining whether the terminal is registered in the registered terminal list.

The transmission source MAC address included in the Ether header of the content acquisition request message is the MAC address (00:FE:98:DC:76:BA) of the Viewer 1601 immediately after transmission from the Viewer 1601. However, upon passing through the router 105, the transmission source MAC address included in the Ether header of the content acquisition request message is rewritten to the MAC address of the router 105.

The transmission source MAC address included in the Ether header of the content acquisition request message M2201 which has arrived at the network connection apparatus 1600 is different from the MAC address of the Viewer 1601. For this reason, the request is determined to be a request from outside the same subnet.

In the fourth embodiment, the network determination processing is performed after the registered terminal determination processing. Instead, the network determination processing may be executed first.

After determining that the content acquisition request is from outside the same subnet, it is determined whether the communication between the network connection apparatus 1600 and the Viewer 1601 is secure. This determination is done by determining whether communication by, for example, SSL or IPSec is being performed. Whether the communication is secure may be determined based on, for example, the policy.

In the fourth embodiment, assume that no secure communication is being performed. Since it is determined that no secure communication is being performed, the network connection apparatus 1600 determines to encrypt the requested content using a common key (PSK2) corresponding to the terminal registered in the registered terminal list and then transmit the encrypted content.

The network connection apparatus 1600 transmits, to the Viewer 1601, a content acquisition response message M2202 including a message representing that an encrypted content is to be transmitted. The network connection apparatus 1600 encrypts the requested content by the common key (PSK2) and transmits it to the Viewer 1601 (M2203).

Note that in this embodiment, data providing to a terminal that is not registered is rejected. Instead, unencrypted image data may be transmitted to a terminal that is not registered.

Registered terminal determination processing is performed. However, the processing may continue without performing the registered terminal determination.

Whether to perform encryption is determined depending on whether the communication is secure. However, the processing may continue without determining whether the communication is secure.

The content acquisition response message includes a message representing the presence/absence of content encryption. However, the presence/absence of encryption need not always be included. The content acquisition response message need not necessarily be transmitted.

In the registered terminal determination processing, whether the terminal is registered is determined by including a MAC address in the payload of the content acquisition request message. However, the present invention is not limited to this, and any other information capable of identifying the registered terminal is usable.

In the network determination processing, the transmission source MAC address included in the Ether frame is compared with the MAC address registered in the registered terminal list. Instead, any other information capable of determining whether the subnet is the same is usable. For example, the determination may be done using an IP address. Alternatively, whether the subnet is the same may be determined based on a subnet mask, RA (Router Advertise) of IPv6, or the like.

A protocol capable of determining whether the terminal exists in the same subnetwork may be used. For example, a protocol such as LLDP (Link Layer Discovery Protocol: IEEE802.1AB) may be used to determine whether the subnetwork is the same. Otherwise, whether the subnetwork is the same may be determined upon receiving a specific protocol. For example, when ssdp is received, the subnetwork can be determined to be the same.

As the communication parameter, a wireless LAN has been described. However, for example, Bluetooth® may be used in place of it.

As the communication parameter providing method, a providing method using a wireless LAN has been described. However, the present invention is not limited to this, and any other method capable of providing communication parameters to a terminal apparatus is usable. For example, a USB memory or NFC (Near Field Communication) may be used to provide the parameters.

As described above, when setting communication parameters, a common key in the communication parameters is recorded in the registered terminal list in correspondence with each terminal. In response to a content request, it is determined whether it is a request from the same subnet. If it is a request from outside the same subnet, the content is encrypted using the common key for each terminal and transmitted. This improves the security level and convenience.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-005132, filed Jan. 13, 2009 which is hereby incorporated by reference herein in its entirety.

What is claimed is:

1. A communication apparatus comprising:
a determination unit that determines whether or not to execute encryption of data in accordance with a communication channel from the communication apparatus to another communication apparatus when the data is transmitted to said another communication apparatus; and
an encryption unit that encrypts at least part of the data in a case where it is determined by the determination unit that the encryption is to be executed.

2. The apparatus according to claim 1, wherein the determination unit comprises a unit that searches a network connected to the communication apparatus and a network connected to said another communication apparatus, and determines whether to directly or indirectly transmit the data to said another communication apparatus based on a search result.

3. The apparatus according to claim 2, wherein the determination unit determines that the encryption is not to be executed in a case where the data is directly transmitted to said another communication apparatus, or the encryption is to be executed in a case where the data is indirectly transmitted to said another communication apparatus.

4. The apparatus according to claim 2, wherein the determination unit determines that the encryption is to be executed in a case where said another communication apparatus is connected to a network different from the network connected to the communication apparatus upon directly transmitting the data to said another communication apparatus.

5. The apparatus according to claim 3, wherein the indirectly transmitting the data indicates transmitting the data via a proxy server which transfers or holds the data.

6. The apparatus according to claim 1, wherein the determination unit determines that the encryption is not to be executed in a case where the communication channel to said another communication apparatus is encrypted.

7. The apparatus according to claim 1, wherein the encryption unit encrypts the data using an encryption key used for setting a communication parameter.

8. A communication method executed in a communication apparatus, comprising:
determining whether or not to execute encryption of data in accordance with a communication channel from the communication apparatus to another communication apparatus when the data is transmitted to said another communication apparatus; and
encrypting at least part of the data in a case where it is determined in the determining step that the encryption is to be executed.

9. A program recorded in a computer-readable recording medium, the program for causing a computer to execute a communication method of claim 8.
